(19) United States
(12) Patent Application Publication
(10) Pub. No.: US 2008/0278954 A1
(43) Pub. Date: Nov. 13, 2008

(54) Mounting Assembly for Optoelectronic Devices

(75) Inventor: Ingo Speier, Saanichton (CA)

Correspondence Address: PHILIPS INTELLECTUAL PROPERTY & STANDARDS, 3 BURLINGTON WOODS DRIVE, BURLINGTON, MA, 01803, US

(73) Assignee: TIR SYSTEMS LTD., Burnaby, BC (CA)

(21) Appl. No.: 10/597,493

(22) PCT Filed: Apr. 5, 2006
(86) PCT No.: PCT/CA2006/000500

§ 371 Date: Jul. 25, 2008

Related U.S. Application Data
(60) Provisional application No. 60/668,821, filed on Apr. 5, 2005.
(60) Provisional application No. 60/772,651, filed on Feb. 10, 2006.

(51) Int. Cl. F21V 29/00

(52) U.S. Cl. 362/373

(57) ABSTRACT

The present invention provides a mounting assembly for one or more light-emitting elements, wherein the mounting assembly is configured such that the one or more light-emitting elements are inferiorly connected to a carrier. The carrier comprises one or more light transmission regions, wherein each of the one or more light-emitting elements is aligned with a light transmission region enabling light to pass through the carrier. The inferior mounting of the light-emitting elements can provide ease of thermal access to a cooling interface associated with the one or more light-emitting elements by a thermal management system.

### FIELD OF THE INVENTION

The present invention pertains to the field of illumination systems and in particular to a mounting technology for optoelectronic devices.

### BACKGROUND

Advances in the development and improvements of the luminous flux of light-emitting devices such as solid-state semiconductor and organic light-emitting diodes (LEDs) have made these devices suitable for use in general illumination applications, including architectural, entertainment, and roadway lighting. Light-emitting diodes are becoming increasingly competitive with light sources such as incandescent, fluorescent, and high-intensity discharge lamps.

Light-emitting diodes offer a number of advantages and are generally chosen for their ruggedness, long lifetime, high efficiency, low voltage requirements, and the possibility to control the colour and intensity of the emitted light independently. Light-emitting diodes provide an improvement over delicate gas discharge lamp, incandescent or fluorescent lighting systems. Solid-state semiconductor and improvingly organic light-emitting diodes have the capability to create the same outstanding lighting impressions.

Unlike classical incandescent light sources which can emit almost all of the generated waste heat in the form of infrared radiation, most of the heat generated in LEDs is first absorbed by the material structures comprising the optically and electrically active regions inside the LED die. The LED die itself therefore can obstruct heat transfer to the environment. Despite the higher electro-optical conversion efficiency, thermal management is of particular relevance in LED luminaire design. The efficiency and longevity of light-emitting diodes is strongly affected by temperature and hence LEDs typically require combinations of passive or active cooling mechanisms in order to maintain acceptable operating temperature conditions. For fixed parameters such as packaging and employed LED die materials, factors of aging such as the durability and reliability of light-emitting diodes are substantially governed by operating temperature conditions.

In this respect, the mounting technology of LED die and LED packages is of particular importance in managing the device operating temperature effectively.

LED die or packages together with other components can be placed on a thermally well conducting single carrier for example a metal core printed circuit board (MCPCB) or a ceramic carrier (for example a low temperature co-fired ceramic on metal substrate). The MCPCB absorbs and disperses heat from the LEDs; however, it heats up. Consequently, using a thermally well conducting carrier for high density LED mounts, typically raises the operating temperature for all other components attached to the MCPCB. Furthermore the placement of LED die or packages on top of the carrier adds further layers that the heat has to propagate through in order to be conducted away from the LEDs, thereby resulting in increased thermal resistance.

United States Patent Application No. 2005/0243558 describes a lamp assembly and methods of assembling same. The lamp assembly comprises a printed circuit board (PCB) having a face surface, a rear surface opposite the face surface, electrical traces on the rear surface, and an opening extending from the face surface to the rear surface, and a LED emitter having a dome portion, a body, and a plurality of electrical terminals connected to the body, wherein the body of the LED emitter is adjacent the rear surface, the dome portion of the LED emitter extends through the opening in the PCB to the face surface, and the electrical terminals are connected to the electrical traces on the rear surface. This configuration of the lamp assembly, however, requires a very thin PCB such as a flexible circuit board in order to be optically efficient. This patent application focuses on the visibility of the electrical traces for direct viewing and does not try to improve thermal access and reduce thermal resistance to the LED packages utilized.

U.S. Pat. No. 6,930,332 describes a light-emitting device that can provide enhanced heat radiation as well as allowing light from a LED chip to be efficiently extracted out of the device. This light-emitting device includes a metal plate that is made of aluminum. The metal plate has a projection projecting forward and the projection has a front side provided with a housing recess. A LED chip is mounted on the bottom of the housing recess so that it is thermally coupled to the metal plate, thus allowing heat to be radiated. A PCB, having a glass epoxy substrate is joined to the front surface of the metal plate and is provided with an insertion hole into which the projection is inserted. The LED chip and a bonding wire are encapsulated in a transparent resin seal portion. The side wall of the housing recess that is part of the metal plate functions as a reflector for reflecting forward the light emitted from the LED chip. Thus, light from the LED chip can be extracted efficiently. In this configuration, the substrate and heat sink are formed as one unit and configured substantially as a heat spreader similar to a MCPCB. Additionally the PCB and the components mounted thereto will essentially reach the same temperature as the metal substrate as the parts are in intimate thermal contact.

Therefore there is a need for a mounting assembly that can enhance the thermal management of the optoelectronic devices.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a mounting assembly for optoelectronic devices. In accordance with an aspect of the present invention, there is provided a light-emitting apparatus connectible to a thermal management system, the apparatus comprising: a carrier including one or more light transmission regions; and one or more light-emitting elements for generating light, each of the one or more light-emitting elements mounted on a substrate having a cooling interface, the substrate being inferiorly mounted onto the carrier in order that each of the one or more light-emitting elements are proximate to one of the one or more light transmission regions, wherein the cooling interface is directed away from the carrier and is adapted for connection to a thermal management system; wherein the one or more light-emitting elements are adapted for connection to a source of power for activation thereof.

In accordance with another aspect of the invention, there is provided a light-emitting apparatus connectible to a thermal management system, the apparatus comprising: a carrier including one or more light transmission regions; and one or more light-emitting elements for generating light, each of the one or more light-emitting elements having a cooling interface, said light-emitting elements being directly inferiorly mounted onto the carrier in order that each of the one or more light-emitting elements are proximate to one of the one or more light transmission regions, wherein each cooling interface is directed away from the carrier and each cooling interface is adapted for connection to a thermal management system; wherein the one or more light-emitting elements are adapted for connection to a source of power for activation thereof.

In accordance with another aspect of the present invention, there is provided a method for forming a light-emitting apparatus connectible to a thermal management system, the method comprising the steps of: providing a carrier having one or more light transmission regions; aligning one or more light-emitting elements with one of the light transmission regions, each of the one or more light-emitting elements having a cooling interface; inferiorly coupling the one or more light-emitting elements to the carrier; thereby forming the light-emitting apparatus.

### BRIEF DESCRIPTION OF THE FIGURES

FIG. 1 illustrates a mounting assembly according to one embodiment of the present invention.

FIG. 2 illustrates a mounting assembly according to another embodiment of the present invention.

FIG. 3A illustrates a mounting assembly according to another embodiment of the present invention.

FIG. 3B illustrates the housing or package of the light-emitting element of FIG. 3A.

FIG. 4 illustrates a mounting assembly which is in thermal contact with a thermal management system according to one embodiment of the present invention.

FIG. 5 illustrates multiple mounting assemblies which are in thermal contact with a thermal management system according to one embodiment of the present invention.

FIG. 6 illustrates a mounting assembly in which a substrate forms an integral body with part of a thermal management system according to one embodiment of the present invention.

FIG. 7 illustrates a mounting assembly with an integrated variable focal-length fluid lens according to one embodiment of the present invention.

FIG. 8A illustrates a mounting assembly with a light-emitting element which is directly affixed to a carrier according to one embodiment of the present invention.

FIG. 8B illustrates a light-emitting element which can be directly affixed to a carrier according to one embodiment of the present invention.

FIG. 8C illustrates a light-emitting element which has a textured emission window according to one embodiment of the present invention.

FIG. 8D illustrates a light-emitting element is affixed to a carrier according to one embodiment of the present invention.

FIG. 8E illustrates a light-emitting element which is affixed to a carrier with multiple conducting planes according to one embodiment of the present invention.

FIG. 9 illustrates a mounting assembly of attached light-emitting elements which is in thermal contact with a two stage thermal management system according to one embodiment of the present invention.

FIG. 10 illustrates a mounting assembly with a transparent carrier according to one embodiment of the present invention.

FIG. 11 illustrates a mounting assembly according to another embodiment of the present invention.

FIG. 12 illustrates the mounting assembly as illustrated in FIG. 11, with a connecting secondary optic and a thermal management system.

### DETAILED DESCRIPTION OF THE INVENTION

### Definitions

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “thermal management system” is used to define an element providing a means for thermal energy transfer. A thermal management system can be designed to incorporate thermal removal techniques including but not limited to conductive and convective cooling, liquid cooling, phase change cooling and forced air cooling. Thermal management systems can comprise heat pipes, thermosyphons, thermoelectrics, thermotunnels, heat spreaders, heat sinks, spray cooling systems, macro or micro channel cooling systems, thermoelectric cooling systems or other appropriate thermal management systems as would be known to a worker skilled in the art.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

Thermal management is a key to ensure appropriate thermal operating conditions of light-emitting elements, wherein these light-emitting elements can generate high amounts of waste heat in concentrated small spaces and typically require effective cooling. In addition a level of thermal isolation between the light-emitting elements and other necessary temperature sensitive components can be required in order to limit the thermal impact that the light-emitting elements have on these temperature sensitive components.

The present invention provides a mounting assembly for one or more light-emitting elements, wherein the mounting assembly is configured such that the one or more light-emitting elements are inferiorly connected to a carrier. The carrier comprises one or more light transmission regions, wherein each of the one or more light-emitting elements is aligned with a light transmission region enabling light to pass through the carrier. The inferior mounting of the light-emitting elements can provide ease of thermal access to a cooling interface associated with each of the one or more light-emitting elements by a thermal management system.

In one embodiment of the present invention the light-emitting elements are mounted on a thermally conductive substrate and this assembly is in turn inferiorly mounted to the carrier. In another embodiment of the present invention, the light-emitting elements are directly inferiorly mounted to the carrier wherein a surface of the light-emitting element interfaces directly with the carrier.

Due to the inferior mounting of the one or more light-emitting elements relative to the carrier, the emission of light generated by the one or more light-emitting elements will be directed at the carrier and therefore the one or more light transmission regions provide a means for light transmission through the carrier. In one embodiment of the present invention the one or more light transmission regions are defined by openings or apertures formed within the carrier. Alternately, a transparent carrier or regions of transparency defined in the carrier can provide the one or more of the light transmission regions.

In one embodiment, the number and thickness of layers between the one or more light-emitting elements and the thermal management system are reduced in comparison to current solutions thereby resulting in improved thermal performance and reduced junction temperature.

The inferior mounting of the one or more light-emitting elements relative to the carrier can provide a level of thermal isolation of the carrier from the heat generated by the one or more light-emitting elements. In this manner, any required thermally sensitive electronic devices can be mounted on the carrier thereby reducing the thermal impact of the one or more light-emitting elements thereon.

In one embodiment, one or more light-emitting elements are mounted onto a thermally conductive substrate wherein the substrate is inferiorly mounted onto the carrier. Each of the light-emitting elements is aligned with a light transmission region defined in the carrier. In this embodiment, the substrate can comprise electronic and mechanical couplings enabling the mounting of the substrate to the carrier and for providing electrical interconnection to the one or more light-emitting elements for activation thereof. A cooling interface of the substrate is positioned away from the carrier and provides a location to which a thermal management system can be coupled in order to extract the heat generated by the one or more light-emitting elements.

In one embodiment, a light-emitting element can be configured such that it can be inferiorly mounted directly to the carrier, wherein the light-emitting element is aligned with a light transmission region defined in the carrier. In this embodiment, an appropriately designed light-emitting element can provide all electronic and mechanical functionality required to mount the light-emitting element onto the carrier and electrically activate it. The light-emitting element can be directly inferiorly mounted onto the carrier in such a way that effective thermal accessibility to the cooling interface of each of the one or more light-emitting elements is provided, in addition to a substantially unobstructed emission of light by the light transmission region.

### Substrate

In one embodiment, the substrate provides a surface upon which the one or more light-emitting elements are mounted. The substrate is configured to matingly connect with a carrier in a manner that the substrate is inferiorly interconnected with the carrier, thereby providing a predetermined level of thermal access to the one or more light-emitting elements.

The substrate can be made of thermally conductive material, for example ceramics such as AlN, Al₂O₃, BeO, a MCPCB, direct bond copper (DBC), or low temperature co-fired ceramic. Furthermore the substrate can be fabricated from a metal, for example Olin 194, Cu, CuW or any other alloy and can be dielectrically coated and electrical traces can be deposited onto the substrate to allow electrical connectivity. In addition, alternate thermally conductive materials may be used for example monolithic carbonaceous materials, metal matrix composites (MMCs), carbon/carbon composites (CCCs), ceramic matrix composites (CMCs), polymer matrix composites (PMCs), and advanced metallic alloys. Other thermally conductive materials would be known to a worker skilled in the art.

In one embodiment, the substrate can be designed with circuit traces providing electrical connections to one or more light-emitting elements and other electronic devices which may be attached thereto. These circuit traces can be defined on one side of the substrate only, wherein this configuration can simplify manufacturing and improve cost effectiveness of the mounting assembly. Alternately, the circuit traces can be provided on two sides of the substrate.

In another embodiment, the substrate can be designed to comprise multiple electrically conducting planes in order to reduce the size of the substrate and increase the potential density of the one or more light-emitting elements and potential other electronic devices mounted thereon due to the reduction of circuit traces, for example.

In one embodiment of the present invention the substrate can have separate designated contact pads to interface mechanically and electrically to the carrier. In an alternate embodiment, electrical contact pads associated with the substrate and the carrier can additionally provide a mechanical mounting interface, for example by solder reflow or electrically conductive epoxy adhesion of the substrate to the carrier.

The substrate can be flat, curved or configured to have any other desired shape. The shape of the substrate can be determined based on the desired application of the mounting assembly and/or depend on the manufacturing techniques being used.

In one embodiment of the present invention, the substrate comprises indexing features which provide a means for aligning the substrate into a desired orientation relative to the carrier, prior to coupling thereto.

In one embodiment of the present invention, the substrate has two or more surfaces, wherein a first surface is proximal to the one or more light-emitting elements. This first surface can further carry electrical traces to activate the light-emitting elements, for example. A second surface distant to the one or more light-emitting elements is configured to provide thermal access to the thermal management system, which is in thermal contact with the second surface. In one embodiment, the second surface can be designed to substantially reduce the thermal resistance between substrate and the thermal management system. In one embodiment of the present invention, the thermal connection between the second surface of the substrate and the thermal management system can be enhanced through the use of thermally conductive grease, thermally conductive epoxy or other thermally conductive material.

In one embodiment one or more optics can be mounted to the substrate in order to provide for manipulation of the light emitted by the one or more light-emitting elements mounted thereon. The optics can be refractive optics, reflective optics, diffractive optics or other type of optics, as would be readily understood by a worker skilled in the art.

In one embodiment the optic is a dome lens with a designated pocket, wherein the dome lens can be mounted onto the substrate enclosing the one or more light-emitting elements within the designated pocket. In addition, free space within the designated pocket may be filled with an encapsulation material thereby substantially sealing the region between the one or more light-emitting elements and the dome lens. The encapsulation material can be an optical silicone or other suitable material as would be known to a worker skilled in the art.

In one embodiment of the present invention, the substrate includes indexing features which can provide a means for aligning the placement of one or more optics with respect to the substrate, prior to mounting thereon. Furthermore, indexing features can be associated with the substrate which can provide a means for the alignment of the one or more light-emitting elements prior to mounting thereon.

In one embodiment, upon the substrate can be mounted one or more light-emitting elements and optionally one or more sensors. The sensors can be optical sensors, temperature sensors or the like. An optical sensor can be a photodiodes, photosensor, or light-emitting element configured to act as an optical sensor or other optical sensor as would be readily understood. A temperature sensor can be a thermocouple, thermister or other known type of temperature sensor as would be known to a skilled worker. It would be readily understood that the operation of any sensor or electronic device mounted on the substrate with the one or more light-emitting elements would be directly impacted by the heat generated by the one or more light-emitting elements.

### Carrier

The carrier is configured to support the one or more light-emitting elements which are inferiorly mounted thereto. As the carrier is positioned such that it is not in the thermal path of the one or more light-emitting elements, the carrier is not required to be a thermal conductor. Therefore the carrier can be made from a standard board type material, for example a FR4 compound material. Optionally, the carrier can also be fabricated from thermally conductive material, for example ceramics such as AlN, Al₂O₃, BeO, metal, alloy, or any other thermally conductive material or MCPCB as would be readily understood by those skilled in the art.

In one embodiment, the carrier can be designed such that circuit traces providing electrical connections to one or more light-emitting elements attached thereto are formed on one side of the carrier, namely the side facing the light-emitting elements. This placement of circuit traces may simplify manufacturing and improve cost effectiveness of the carrier. Alternately the carrier can have electrical connections on both sides thereof.

In one embodiment, the carrier can be designed to comprise multiple electrically conducting planes in order to reduce the size of the carrier and increase the potential density of electronic and optoelectronic devices mounted thereon for example. In one embodiment of the present invention the carrier can have separate designated contact pads to interface mechanically and electrically to the substrate or light-emitting elements. In another embodiment of the invention electrical contact pads can additionally provide a mechanical mounting interface by solder reflow or electrical conductive epoxy adhesion between the substrate and the carrier.

In one embodiment, electronic components and circuitry, for example circuitry to activate the light-emitting elements, control circuitry, feedback circuitry, optical sensors or thermal sensors or circuitry therefore, may be mounted on the carrier.

In one embodiment the carrier comprises openings or apertures to accept the inferiorly mounted light-emitting elements and thereby allow for light propagation. The through holes can be shaped to have a desired cross sectional shape and the wall surfaces thereof may be coated with specular or diffuse reflective material to improve the light extraction from the one or more light-emitting elements associated therewith.

In one embodiment the wall surfaces of the openings can be coated with optically active material, such as phosphor.

In one embodiment the openings can be filled with encapsulation material. Additionally the surface of the encapsulation material can be, textured, patterned or stamped. In one embodiment the surface of the encapsulation material can be shaped as one or more of a dome lens, Fresnel lens, diffuser, lenticular lens array or the like.

In one embodiment the openings can be filled with a fluid lens and the wall surface thereof can be configured to act as one or more electrodes for the fluid lens. A window or other transparent component can be placed above the opening in order to provide a seal for the lens and optionally provide one or more electrodes for control of the fluid lens, for example.

In one embodiment the opening is designed to accept therein one or more light-emitting elements together with a primary optic disposed on the substrate.

In one embodiment secondary optics can be associated with the carrier and positioned relative to the one or more light transmission regions associated with the carrier in order to provide further manipulation of the light generated by the one or more light-emitting elements. The carrier can be configured with one or more indexing features in order to provide a means for alignment of the secondary optics relative to the carrier. Optionally, the secondary optics can be inserted and indexed relative to an opening within the carrier.

In one embodiment the carrier is formed from a transparent material and has one or more optical elements formed therein. The one or more optical elements can be configured as a dome lens, a Fresnel lens, lenticular lens array, a diffuser, or other optical element that can be integrally formed in a transparent material as would be known by a worker skilled in the art. In one embodiment, the carrier can configured with designated pockets to accept the light-emitting elements therein upon the inferior mounting thereof. Optionally, encapsulation material can be inserted between the carrier and the light-emitting elements, namely the optically active region of light-emitting elements, which can provide a means for increasing extraction efficiency. Further, in one embodiment circuit traces can be disposed on the transparent carrier and may be located on the surface proximal to the light-emitting elements, wherein these circuit traces can provide electrical connection to the light-emitting elements on the carrier.

In another embodiment of the present invention, openings in the carrier can be configured to mate with an insert. The insert can be configured to optically connect with the one or more light-emitting elements and aid in the light extraction and beam shaping of the light emitted by the one or more light-emitting elements. The cross sectional profile and the surface properties of the insert can be configured in order to substantially maximise light extraction from the one or more light-emitting elements. The insert can be made of metal, plastic, ceramic or any other compound material and press fitted, glued, soldered, bolted, riveted or screwed at the opening locations of the carrier.

In one embodiment the insert interfaces to further optical components, for example a primary optical element or a secondary optical element. A primary optical element may be configured as a dome lens. In a further embodiment of the present invention, a primary optical element can be integrated into the insert.

In one embodiment of the present invention, secondary optical elements, for example reflectors, lenses, diffusers, light guides or other optical elements can be attached to the carrier, wherein these secondary optical elements can provide for additional manipulation of the light emitted by the one or more light-emitting elements inferiorly mounted to the carrier. The secondary optical element may optionally be spaced relative to the position of the one or more light-emitting elements inferiorly mounted to the carrier.

In one embodiment, the carrier includes one or more indexing features which can provide a means for aligning the substrate or optical elements therewith prior to their interconnection to the carrier.

The carrier can be flat, curved or configured to have any other desired shape. The shape of the carrier can be determined based on the desired application of the mounting assembly and/or depend on the manufacturing techniques being used.

In one embodiment of the present invention one or more substrates can be mounted to a single carrier. In another embodiment of the present invention one or more light-emitting elements can be inferiorly mounted directly to the carrier.

In one embodiment of the present invention, a substrate can be inferiorly mounted to the carrier by a solder reflow process which can provide mechanical and electrical connection there between. Alternate connection means for example gluing, soldering, bolting, riveting or screwing or the like may provide for the mechanical connection between the substrate and the carrier. Optionally, an epoxy adhesive can be used to enhance mechanical strength of the connections between the substrate and the carrier.

In one embodiment the substrate or the one or more light-emitting elements can be mechanically connected to the carrier and additionally electrically connected to a source of power. The electrical connection between the one or more light-emitting elements and the source of power can form an integral part of the carrier, for example in the form of circuit traces on the carrier. The mechanical connection between the carrier and the one or more light-emitting elements or the substrate can be made in the form of a solder joint, a cold solder, or adhesive joint, for example. This mechanical connection may additionally be electrically conductive and used to electrically connect the one or more light-emitting elements, for example.

In one embodiment, the substrate and the carrier can have contact elements, for example contact pads, such that an electrical connection can also be formed by a mechanical fixture pressing the contact elements against each other. The fixture can be, for example, a clamping system that clamps the substrate to the carrier or vice versa, or it can be any other pressure assisted connection. In one embodiment, a clamping system allows for lateral movement of the substrate relative to the carrier, thereby reducing the mechanical stress resulting from different thermal expansion coefficients during assembly and thermal cycling. In one embodiment, electrical connection can be provided on one or more sides of the substrate and the carrier to the one or more light-emitting elements by electrical contact elements.

In one embodiment electrical connection between carrier and substrate or the one or more light-emitting elements can also be established via wire bonding.

### Thermal Management System

The thermal management system is in thermal contact with a cooling interface of each of the one or more light-emitting elements or it can be in contact with the cooling interface of the substrate upon which the one or more light-emitting elements are mounted. The thermal management system can be thermally connected to the appropriate cooling interface, namely that of the one or more light-emitting elements or that of the substrate, for example, via a thermally conductive compound, thermally conductive film, thermally conductive solder, thermally conductive adhesive or the like.

The thermal management system can be any combination of a heat sink, heat pipe; thermosyphon, spray cooling system, macro or micro channel cooling system, thermoelectric cooling system or other appropriate thermal management system as would be known to a worker skilled in the art. The thermal management system can comprise one or more integral, independent or redundant cooling systems which can be in thermal contact with the cooling interface associated with each of the one or more light-emitting elements or the substrate.

In one embodiment, the mounting assembly comprises one or more light-emitting elements mounted on a substrate that is inferiorly mounted onto the carrier. The substrate can be thermally conductive thereby providing thermal connectivity between the cooling interface of each of the one or more light-emitting elements and a thermal management system thermally coupled to the substrate. In one embodiment, a mounting assembly comprising the substrate can be attached to the carrier in order that mechanical and electrical connectivity is provided, while limiting thermal connectivity between the substrate and the carrier.

In one embodiment, an “evaporative” portion of one or more heat pipes is thermally connected to the cooling interface to extract the heat generated by the one or more light-emitting elements the heat pipe distributes the heat over a “condenser” portion thereof, which may optionally be in thermal contact to a secondary cooling system, for example a finned heat sink.

In one embodiment the light-emitting elements are directly mounted to the thermal management system, which in turn is mounted inferior to the carrier. In this embodiment electrical connection between the light-emitting elements and the carrier can be achieved by traces deposited on the thermal management system and designated contact pads between carrier and thermal management system. Alternatively electrical connection to the light-emitting elements can be achieved by wire bonding either directly to the light-emitting elements or by wire bonding to contact pads disposed on the thermal management system. In one embodiment, the light-emitting elements can be disposed on a dielectrically coated heat pipe which can additionally comprise circuit traces and the heat pipe can be inferiorly mounted to a carrier.

The invention will now be described with reference to specific examples. It will be understood that the following examples are intended to describe embodiments of the invention and are not intended to limit the invention in any way.

### EXAMPLES

### Example 1

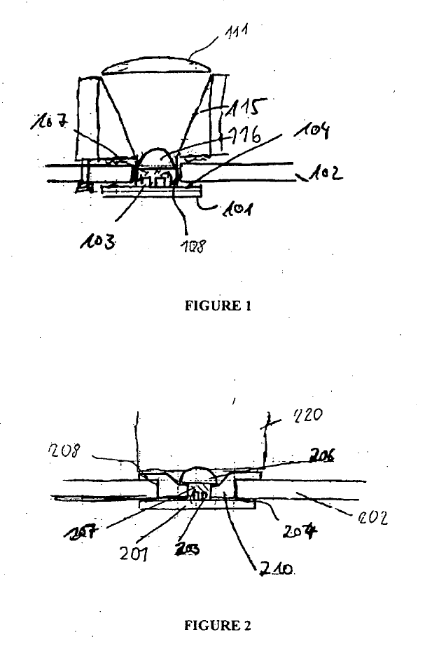

FIG. 1 illustrates a mounting assembly according to an embodiment of the present invention. The mounting assembly comprises one or more light-emitting elements 103 which are attached to a metallized and patterned substrate 101 to allow for electrical connectivity of the light-emitting elements 103. The substrate can be made of AlN, for example or other suitable material and would be known to a skilled worker. The substrate is removably attached to a FR4 carrier 102. This removable attachment may be provide by solder reflow for example or other suitable attachment technique. The carrier 102 has a through hole opening for receiving the one or more light-emitting elements.

A primary optical system is disposed on the substrate including a dome lens 116, a wall surface 108 and encapsulation material 107. A secondary optical system comprises a hollow reflector 115 and a collimating lens 111. The primary and secondary optical systems are configured to extract light emitted by the one or more light-emitting elements under operating conditions and collimate the light beam and mix light of different colours or emission spectra. An optical index matching material 107 can be inserted in the cavity between the light-emitting elements 103, the substrate 101 the wall surface 108 and the dome lens 116 to enhance light extraction from the one or more light-emitting elements 103. The secondary optical system can be removably attached to the carrier 102, wherein the connection between the secondary optical system and the carrier can be provided by bolts, screws, friction or the like. The carrier 102 can be connected to the substrate 101 by solder or electrically conducting epoxy by contact pads 104.

In an alternate embodiment, the substrate 101 can be mechanically clamped to the carrier 102. A thermal management system, which is not illustrated, can be thermally connected to the bottom of the substrate 101 thereby enabling removal of heat generated by the one or more light-emitting elements.

### Example 2

FIG. 2 illustrates a mounting assembly according to an embodiment of the present invention in which an insert 210 is used. The assembly comprises a carrier 202 with an opening 208 there through for receiving one or more light-emitting elements 203 mounted on the substrate 201 from one side and an insert 210 from an opposing side. In this embodiment the light-emitting elements and substrate are non-removably mounted to the carrier and thereby form a single unit. The insert 210 is positioned in the opening 208 and can receive light emitted by the one or more light-emitting elements.

The insert can provide a shaped specular or diffuse reflective surface facing the one or more light-emitting elements and can provide beam shaping and colour mixing of the light emitted by the one or more light-emitting elements under operating conditions. It is understood that the shape of the reflective surface associated with the insert can be adapted to optimize light extraction from a predetermined arrangement of the one or more light-emitting elements.

The mounting assembly further comprises a primary optic 206, for example a dome lens, which can be attached to the insert 210 and it is understood that the insert can comprise further optical elements. The substrate 201 can be attached to the carrier 202 with adhesives or solder and electrical connections to the carrier 202 can be achieved by solder or electrically conducting adhesive applied to designated contact pads 204. Optionally, the mechanical coupling between substrate and carrier can be enhanced by application of adhesive applied there between, for example.

An optical encapsulation material 207 can be inserted in the cavity between the insert 210, the primary optics 206, the one or more light-emitting elements 203 and the substrate 201.

A thermal management system, which is not illustrated, can be thermally connected to the bottom of the substrate 201 thereby enabling removal of heat generated by the light-emitting elements.

A secondary optical element 220 can be mounted on the carrier, wherein the secondary optical element can be provided for further manipulation of the light emitted by the light-emitting elements.

The insert 210 can be made of metal for example Al or it can be fabricated from plastics, ceramics or other suitable materials which would be obvious to those skilled in the art. The insert 210, when made of an electrically non-conductive material, can directly contact the substrate or can be spaced from the substrate.

In one embodiment, when the insert is manufactured from an electrically conductive material, the insert 210 is positioned and configured such that it does not contact any circuit traces or other electrical contacts associated with either the carrier or the substrate. For example, the insert can be configured to leave an appropriate amount of space or can be mounted such that it rests on pads that electrically isolate the insert from any electrical circuits or contacts associated with the substrate or the carrier.

In one embodiment of the present invention, the insert can be designed to aid in the reduction of thermally induced differential strain between the carrier, substrate, for example.

### Example 3

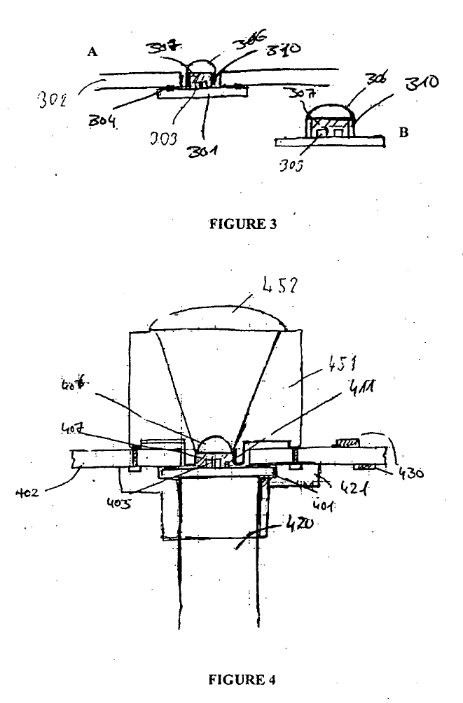

FIG. 3A illustrates a mounting assembly in which a lighting device package is removably mounted inferiorly to the carrier. The lighting device package is further illustrated in FIG. 3B.

The lighting device package comprises a circumferential wall 310 which is attached to the substrate 301 together with one or more light-emitting elements 303 and a primary optical element 306. The interior of the lighting device package can be filled with an encapsulation material 307 and the substrate 301 can be manufactured from direct bonded copper or metallized AlN, for example, and can comprises electrical traces which are patterned on the top surface.

The wall structure 310 can be metallic and can also serve as an optical element, for example the wall structure can have a shaped reflective surface facing the one or more light-emitting elements 303. The wall structure can also be made of plastic, for example a liquid crystal polymer, ceramics or other compound materials. The wall structure can have any desired cross sectional shape and can be coated in optically active material such as phosphor.

The combination of the wall structure 310, substrate 301, and primary optical element 306 can seal the one or more light-emitting elements 303 from the environment and can be attached and electrically connected by the solder pads 304 to the carrier 302. The carrier comprises one or more openings there through for the positioning of the light-emitting package therein.

It is understood, that the carrier can be connected to the substrate by separate mechanical pads and electrical pads or that mechanical mounting functionality and electrical conductivity can be achieved through common pads and electrically conductive epoxy or solder.

In one embodiment, one or more temperature sensors, optical sensors, or other sensors can be positioned proximate to the one or more light-emitting elements on the substrate or the carrier. The carrier may optionally have further electronic devices, electrical components or electrical circuits thereon which can provide additional functionality to the lighting device package.

In one embodiment, the encapsulation material 307 can comprise optically active materials such as phosphors or quantum dots.

### Example 4

FIG. 4 illustrates a mounting assembly 400, wherein this example illustrates the thermal interface between the substrate and thermal management system according to one aspect of the present invention.

The mounting assembly comprises a carrier 402, an optical system, one or more electronic devices 430 attached to the carrier, a substrate 401 which can have one or more light-emitting elements 403 and one or more sensors 411. The optical system comprises a reflector 451, a transparent optical element 452, for example a plano-convex lens, a dome lens 406 and encapsulation material 407 injected into the clearance between the dome lens 406, reflective element 451, light-emitting element 403 and the substrate 401.

The substrate can be soldered or glued to the carrier at a location of a through opening within the carrier. The optical system can be affixed to the carrier by screws, bolts, rivets, solder, adhesive, or any other mounting mechanism known in the art.

A thermal management system, which is illustrated as a heat pipe 420 in this example, is mounted to the cooling interface of the substrate 401. In order to reduce the mechanical stress on the cooling interface between the heat pipe and substrate, a collar 421 can be attached to the carrier to support and guide the received heat pipe. The collar can comprise features that retain the heat pipe in a fixed position relative to the substrate. It is understood that the heat pipe can be permanently affixed by, for example, solder, adhesive, or it can be clamped, screwed, bolted or otherwise attached to be non-destructively detachable, wherein this connection can be configured to enhance thermal transfer between the substrate and the heat pipe. Thermal conductivity enhancing material can be for example a thermal paste, thermally conducting adhesive or thermally conducting film or solder provided at the interface between the substrate and the heat pipe. Optionally, the heat pipe can be replaced with a thermosyphon, or any other thermal management system as would be obvious to those skilled in the art.

In one embodiment, additional electronic devices 430 can be mounted onto the carrier, wherein these electronic devices can be temperature sensors, optical sensors, controllers or control circuitry, or other electronic devices as would be readily understood by a worker skilled in the art.

### Example 5

According to an embodiment of the present invention, FIG. 5 illustrates multiple mounting assemblies 510 which are thermally connected to a horizontally disposed thermal management system 520. The mounting assemblies 510 can be configured as those described in relation to FIG. 2.

The thermal management system can be in direct thermal contact with one or more substrate cooling interfaces of the mounting assemblies. The cooling interfaces of the mounting assemblies and the respective fitting surface areas of the thermal management system can be flat or have any other desired shape provided that thermal transmission there between achieves a desired threshold.

In one embodiment the thermal management system can be a heat pipe wherein the interfaces between a mounting assembly and the heat pipe are located between the ends of the heat pipe. The sections of the heat pipe that are in contact with the substrate can be flat to enhance heat extraction from the substrate.

In an alternate embodiment the thermal management system 520 can be a flat heat pipe, an embedded heat pipe system or a fluid cooled plate, for example.

### Example 6

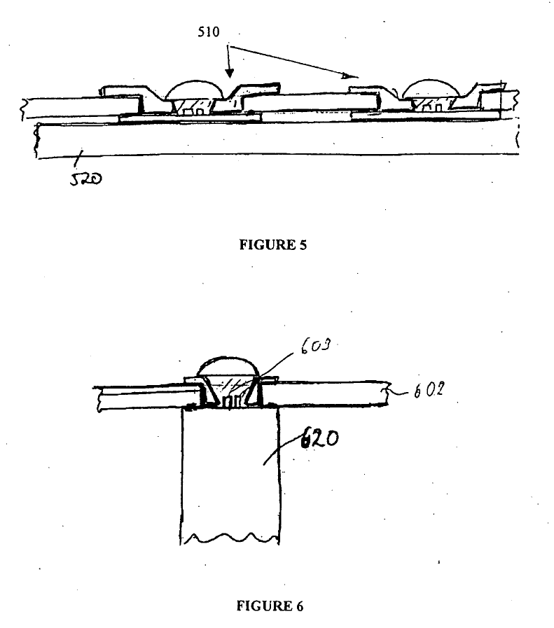

According to one embodiment of the present invention, FIG. 6 illustrates a mounting assembly in which the light-emitting elements 603 are mounted directly onto a thermal management system 620, for example a heat pipe, which is subsequently inferiorly coupled to a carrier 602. The mounting surface of the thermal management system upon which the light-emitting elements are mounted comprises a dielectric layer and electrical traces thereon, thereby providing electrical connections to the one or more light-emitting elements and electrical isolation from the thermal management system.

The thermal management system can be mechanically and electrically connected to a carrier 602 for supplying power and control signals to the light-emitting elements.

In one embodiment of the present invention, one or more electronic devices can be positioned on the side or on the end of the thermal management system in addition to the light-emitting elements mounted on the end thereof as illustrated in FIG. 6.

In one embodiment, the thermal management system can be mounted to the carrier on one side thereof. In an alternate embodiment, the thermal management system can be partially or fully inserted into a through opening formed within the carrier.

### Example 7

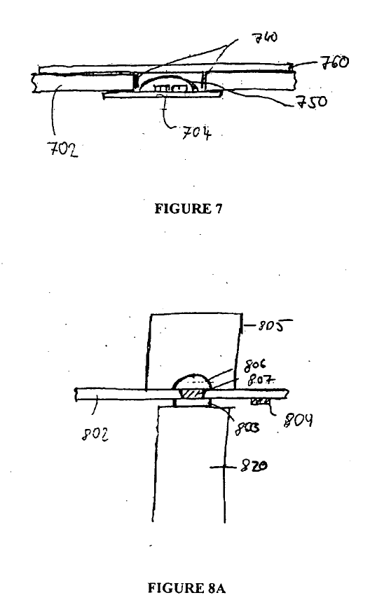

FIG. 7 illustrates a mounting assembly according to another embodiment of the present invention, wherein the mounting assembly comprises an integrated fluid lens 750, positioned in through openings in the carrier 702. The substrate 704 is affixed to the carrier 702 to form a sealed interface with the carrier 702. If required, the inside surfaces of the opening can be coated or otherwise hermetically sealed. The side of the carrier 702 opposing the substrate 704 can be environmentally sealed with a window 760 of transparent material.

The fluid lens can be made of an electromagnetic field induced refractive index changing material, for example, a liquid crystal polymer whose refractive index changes in accordance with an applied electrical field. Alternately, the fluid lens is configured to change its focal length upon the application of an electric field thereto.

In one embodiment, the carrier can have one or more control electrodes 740 positioned on the inner surfaces of the openings. Each control electrode can comprise a single rotation-symmetric or rotation-asymmetric segment, for example in the form of an annular ring which can create a rotation-symmetric electrical field. Control electrodes for manipulation of the fluid lens 750 may be positioned inside, on the far side, or on the near side of the transparent window 760 or can be positioned on the far side or on the near side of the substrate 704.

In one embodiment, the mounting assembly can further comprise one or more transparent dielectric liquids with different optical indices which can act as a controllable optical element, for example a variable focal-length optical lens. The shape of the interface between the dielectric fluids can be adapted to the electrical field conditions which can be controlled by applying voltage differences across a combination of one or more gates or control electrodes. The placement, design, and number of gate and control electrodes required to achieve a desired focal length control are well known to those skilled in the art. The control electrodes can also be part of a housing element, which is not shown, for example, an annular ring, which can be positioned in the opening.

It is understood, that the fluid lens 750 can be positioned freely by combining the variable a focal-length fluid lens with a lens-housing or it can be combined with a housing for an optical index matching material.

In one embodiment a window separates the opening in the carrier 702 into two cavities, wherein one cavity receives the one or more light-emitting elements and encapsulation material and a second cavity contains the fluid lens. The window can be carrying gate or control electrodes for manipulation of the fluid lens.

It is understood that the gate electrodes can be manufactured out of transparent material such as indium tin oxide (ITO) wherever it is required that light can propagate through the electrode.

### Example 8

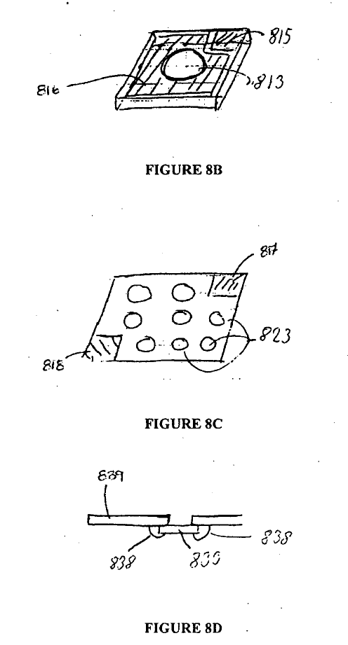

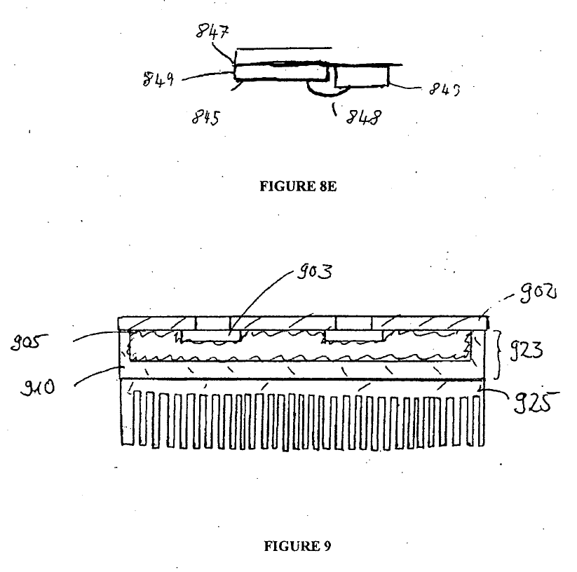

FIG. 8A illustrates a mounting assembly according to an embodiment of the present invention wherein one or more light-emitting elements 803 are directly affixed to a carrier 802 at designated openings. The mounting assembly further comprises an encapsulation material 807 applied into the opening, a primary optical element 806, a secondary optical element 805. Optionally additional electronic devices 809 can be attached to the carrier. A thermal management system 820 is thermally connected to the mounting assembly via a cooling interface of each of the one or more light-emitting elements.

FIG. 8B illustrates a light-emitting element according to an embodiment of the present invention which can be directly affixed to a carrier. The light-emitting element can comprise an emission window 813 and two electrical contact pads 815 and 816, wherein one is negative and the other is positive thereby enabling activation of the light-emitting element. In one embodiment, the emission window is designed to have a required size based on the overall size of the one or more light-emitting elements, thereby substantially maximizing the transmission of the light generated by the one or more light-emitting elements there through.

FIG. 8C illustrates a semiconductor integrated circuit chip which comprises several integrated light-emitting elements (not shown) and light-emitting windows 813. Additionally the integrated circuit chip can comprise electrical contact pads 817 and 818 for control thereof, for example by interfacing to the carrier and a driver. It is understood that the integrated circuit chip can comprise further one or more electronic components, for example photosensors, thermal sensors or the like.

FIG. 8D illustrates how one or more light-emitting elements 833 can be affixed to a carrier 839 which has electrical contacts on one side and one or more emission windows (not shown) for emitting light there through. The one or more light-emitting elements can have electrical connections on one or more sides and can be electrically connected to the carrier, for example, by using wire bonds 838.

FIG. 8E illustrates a mounting assembly wherein the one or more light-emitting elements 843 have electrical contacts on two sides thereof. The carrier can have one or more electrically conductive planes 847 and 845 which are separated by an electrically insulating plane 849, wherein these conductive planes provide electrical connections to the one or more light-emitting elements 843.

In one embodiment a first plane of the carrier provides electrical connection to a first contact of each of the one or more light-emitting elements located on a first surface and a second plane of the carrier can provide electrical connection to a second contact located on an opposing surface of the light-emitting element. For example as illustrated in FIG. 8E, the first contact of the light-emitting element is in direct contact with the first plane 847 of the carrier and the second contact of the light-emitting element is wire bonded 848 to the second plane 845 of the carrier.

In one embodiment, the one or more light-emitting elements can have a patterned emission window to create homogeneous current injection. The pattern can be selected to enhance light extraction out of the one or more light-emitting elements, for example by using photonic crystals. It is also understood that the metallization layer can be manufactured from transparent material such as ITO.

In one embodiment, the semiconductor integrated circuit chip can comprise further integrated electronic components such as one or more of optical sensors and temperature sensors.

In one embodiment, the one or more light-emitting elements have electrical connections on one side thereof providing unobstructed access to an opposite side of the one or more light-emitting elements which can provide the cooling interfaces which can be directly connected to a thermal management system.

### Example 9

FIG. 9 illustrates a mounting assembly comprising a carrier 902 to which one or more light-emitting elements 903 are inferiorly mounted, according to another embodiment of the present invention. The mounting assembly is attached to a two-stage thermal management system. The thermal management system comprises a first stage 923 and a second stage 925 cooling system. The first stage cooling system 923 comprises a phase change cooler, for example a heat pipe system. The heat pipe system is thermally connected to a second stage cooling system 925 which can comprise a finned heat sink. It is readily understood that the first stage and second stage cooling systems can comprise any combination of thermal management systems as would be known to a worker skilled in the art, provided that this combination of thermal management systems would provide the desired heat dissipation of the heat generated by the one or more light-emitting elements.

In one embodiment, the first stage cooling system 923 can be formed wherein the carrier 902 and the one or more light-emitting elements 903 are hermetically sealed within a housing 910 to create a cavity. A wicking material 905 can be provided on the walls of the carrier and the cooling interface of the one or more light-emitting elements within the cavity. The cavity is charged with an evaporative fluid thereby forming a heat pipe in which the one or more light-emitting elements form a portion of the wall structure.

In an alternate embodiment, the cavity can being filled with a highly thermally conductive fluid that transports heat by convection and conduction away from the one or more light-emitting elements. In a further embodiment a coolant could flow through the cavity to remove the heat generated by the one or more light-emitting elements. In another embodiment, the one or more light-emitting elements within the cavity can be cooled via spray cooling.

### Example 10

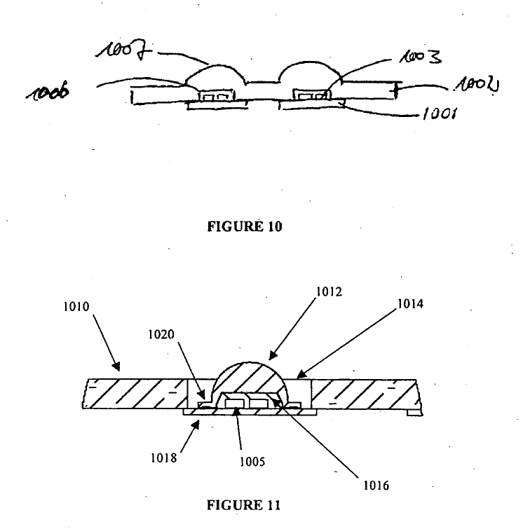

FIG. 10 illustrates a carrier 1002 wherein openings within the carrier are not provided according to one aspect of the invention. In this embodiment, the carrier is formed from a transparent material for example plastic or glass. The carrier can comprise one or more textured or otherwise structured surfaces 1007 providing optical manipulation of the light emitted by the one or more light-emitting elements 1003 inferiorly mounted onto the carrier 1002 by substrate 1001.

The textured or structured surfaces 1007 integral to the carrier can provide optical functionality and can assist in the extraction and beam shaping of light emitted by the one or more light-emitting elements under operating conditions. The structured surfaces can comprise for example one or more optical elements including dome lenses, lenticular arrays, diffractive optics, a holographic diffuser or any other optical element known to a skilled worker in the art.

In one embodiment, a pocket 1006 for receiving the light-emitting elements 1003 is formed within the carrier 1002 at a position proximal to the light-emitting elements. Additionally encapsulation material can be inserted in the pocket between substrate 1001, light-emitting elements 1003 and carrier 1002.

In one embodiment, the carrier can have conductive traces disposed thereon that can provide electrical connection for the one or more light-emitting elements to a source of power or other devices which can be affixed to the carrier.

Optionally the carrier can have secondary optical elements positioned relative to it or attached to it which can be located on the surface opposing or the interface facing the side of the one or more light-emitting elements. These optical elements can be for example, refractive or reflective elements or other desired optical elements as would be readily understood.

### Example 11

FIG. 11 illustrates a mounting assembly according to one embodiment of the present invention. The mounting assembly comprises a thermally conductive substrate 1018, to which is thermally connected one or more light-emitting elements 1005. The mounting assembly further comprises a primary optical element 1012 enclosing the one or more light-emitting elements 1005, wherein the space between the one or more light-emitting elements and the primary optical element 1012 is filled with an encapsulation material 1016, for example an optical silicone. The encapsulation material can have an index of refraction as close as possible to the light-emitting elements to enhance light extraction. Typically the refractive index of commercially available silicones for this type of application is in the order of about 1.4 to 1.6. The primary optical element 1012 can be mounted directly onto the substrate 1018 using an adhesive such as silicone or a thermally or UV curable epoxy or other adhesive known to a worker skilled in the art. In an alternate embodiment, the primary optical element can be held in position through adhesion with the encapsulation material 1016. The primary optical element comprises an attachment site 1020, which can increase the bond line between the primary optical element and the substrate.

The mounting assembly is subsequently aligned with an opening 1014 within the carrier 1010, wherein the substrate is coupled inferiorly to the carrier. In this manner the light emitted by the one or more light-emitting elements associated with the mounting assembly can pass through the opening formed within the carrier.

In one embodiment, electrical traces can be disposed on the substrate to provide electrical connection to the light-emitting elements. Electrical pads on the substrate can provide the electrical and mechanical interface and can correlate to electrical pads provided on the carrier. The substrate can be aligned and oriented and then soldered in place to achieve mechanical and electrical connection between the substrate and the carrier. In one embodiment, further adhesive application can strengthen this mechanical connection between the carrier and substrate.

In one embodiment, additional components such as thermal sensors or optical sensors to sample the optical flux can also be mounted on the substrate.

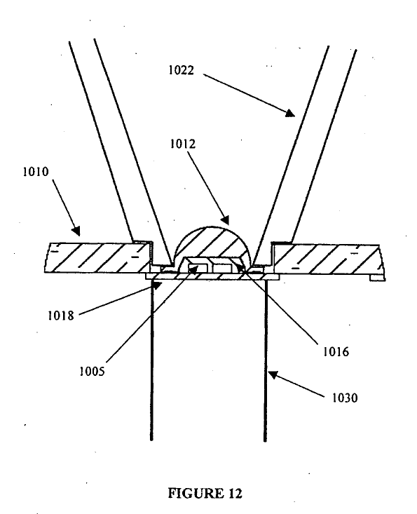

FIG. 12 illustrates a secondary optical element 1020 interfaced to the mounting assembly illustrated in FIG. 11. Provisions, for example indexing features in the carrier can allow the secondary optical element, which may have a highly reflective inner surface to be inserted into the clearing within the opening in the carrier and intimately mate with the primary optical element. In this manner about a maximum amount of the light generated by the light-emitting elements can be extracted with about a minimal aperture size. Furthermore the carrier can serve as an indexing feature in both lateral and vertical directions in order to achieve accurate placement of the secondary optical element and in order to aid in the avoidance of damage to the primary optical element and substrate assembly.

A thermal management system 1030, in this example a heat pipe, interfaces to the cooling interface of the substrate. The thermal connection between thermal management system and substrate can be achieved by soldering the heat pipe and substrate together which may require a metallization layer on the thermal interface of the substrate. Alternately, a thermal epoxy, thermal paste or thermal interface film can be used to enhance the thermal contact between the cooling interface of the substrate and the thermal management system 1030.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

I claim:

1. A light-emitting apparatus connectible to a thermal management system, the apparatus comprising:
a) a carrier including one or more light transmission regions; and
b) one or more light-emitting elements for generating light, each of the one or more light-emitting elements mounted on a substrate having a cooling interface, the substrate being inferiorly mounted onto the carrier in order that each of the one or more light-emitting elements are proximate to one of the one or more light transmission regions, wherein the cooling interface is directed away from the carrier and is adapted for connection to a thermal management system;
wherein the one or more light-emitting elements are adapted for connection to a source of power for activation thereof.

2. The light-emitting apparatus according to claim 1, wherein each of the one or more light transmission regions are defined by either an opening within the carrier or transparent portion of the carrier.

3. The light-emitting apparatus according to claim 1, wherein the substrate comprises circuit traces electrically coupled to the one or more light-emitting elements or the substrate comprises multiple electrically conductive planes electrically coupled to the one or more light-emitting elements.

4. The light-emitting apparatus according to claim 1, wherein the substrate comprises contact pads providing electrical and mechanical connection to the carrier.

5. The light-emitting apparatus according to claim 1, wherein the carrier comprises indexing features for aligning the substrate with the carrier.

6. The light-emitting apparatus according to claim 1, wherein one or more optics are mounted onto the substrate and optically coupled to the one or more light-emitting elements.

7. The light-emitting apparatus according to claim 1, wherein each of the one or more light transmission regions are defined by an opening within the carrier and wherein one or more light-emitting elements are configured to be inserted into one or more of the openings.

8. The light-emitting apparatus according to claim 1, wherein the carrier is fabricated from a thermally conductive material.

9. The light-emitting apparatus according to claim 1, wherein the carrier is fabricated from FR4 board.

10. The light-emitting apparatus according to claim 1, wherein the carrier mates with an insert and said insert is configured to provide extraction of the light and shaping the light into a beam.

11. The light-emitting apparatus according to claim 1, wherein the carrier is fabricated from a transparent material.

12. The light-emitting apparatus according to claim 1, wherein one or more of the light transmission regions is configured as a transparent optical element, wherein the transparent optical element is selected from the group comprising a dome lens, Fresnel lens, lenticular lens array and diffuser.

13. A light-emitting apparatus connectible to a thermal management system, the apparatus comprising:
a) a carrier including one or more light transmission regions; and
b) one or more light-emitting elements for generating light, each of the one or more light-emitting elements having a cooling interface, said light-emitting elements being directly inferiorly mounted onto the carrier in order that each of the one or more light-emitting elements are proximate to one of the one or more light transmission regions, wherein each cooling interface is directed away from the carrier and each cooling interface is adapted for connection to a thermal management system;
wherein the one or more light-emitting elements are adapted for connection to a source of power for activation thereof.

14. The light-emitting apparatus according to claim 13, wherein each of the one or more light transmission regions are defined by either an opening within the carrier or transparent portion of the carrier.

15. The light-emitting apparatus according to claim 13, wherein the carrier comprises indexing features for aligning the one or more light-emitting elements with the carrier.

16. The light-emitting apparatus according to claim 13, wherein each of the one or more light transmission regions are defined by an opening within the carrier and wherein one or more light-emitting elements are configured to be inserted into one or more of the openings.

17. The light-emitting apparatus according to claim 13, wherein the carrier is fabricated from a thermally conductive material.

18. The light-emitting apparatus according to claim 13, wherein the carrier is fabricated from FR4 board.

19. The light-emitting apparatus according to claim 13, wherein the carrier mates with an insert and said insert is configured to provide extraction of the light and shaping the light into a beam.

20. The light-emitting apparatus according to claim 13, wherein the carrier is fabricated from a transparent material.

21. The light-emitting apparatus according to claim 13, wherein one or more of the light transmission regions is configured as a transparent optical element, wherein the transparent optical element is selected from the group comprising a dome lens, Fresnel lens, lenticular lens array and diffuser.

22. A method for forming a light-emitting apparatus connectible to a thermal management system, the method comprising the steps of:
a) providing a carrier having one or more light transmission regions;
b) aligning one or more light-emitting elements with one of the light transmission regions, each of the one or more light-emitting elements having a cooling interface;
c) inferiorly coupling the one or more light-emitting elements to the carrier;
thereby forming the light-emitting apparatus.
